(19) United States
(12) Patent Application Publication
(10) Pub. No.: US 2006/0278777 A1
(43) Pub. Date: Dec. 14, 2006

(54) Adjustable furniture support apparatus

(76) Inventors: Stephen Atkinson, Blackburn (GB); Howard Stockdale, Accrington (GB)

Correspondence Address: MOORE & VAN ALLEN PLLC, P.O. BOX 13706, Research Triangle Park, NC, 27709, US

(21) Appl. No.: 10/534,095

(22) PCT Filed: Nov. 7, 2003
(86) PCT No.: PCT/GB03/04849

§ 371 Date: May 24, 2006

(30) Foreign Application Priority Data
Nov. 9, 2002 (GB) 022618.40

(51) Int. Cl. F16M 11/24; A47F 5/14

(52) U.S. Cl. 248/188.4; 211/182; 403/171

(57) ABSTRACT

Adjustable furniture support apparatus (10) comprises a support leg (12) and retaining means in the form of retaining member (14) which is arranged to retain a support member (16) to the support leg (12). The support member (16) is arranged to extend radially away from the longitudinal axis of the support leg (12) and the support leg (12) is arranged, in use to be in a substantially vertical plane whilst the support member (16) is arranged to be in a substantially horizontal plane. The support member (16) has a retaining flange (26) defined at a longitudinal end thereof which is arranged, in use, to locate within a retaining groove (24) of a collar provided on the support member in order for the support member to be retained at at selected angle about the longitudinal axis of the support leg (12).

### FIELD OF THE INVENTION

The present invention relates to adjustable furniture support apparatus, an item of furniture comprising adjustable furniture support apparatus, a method of adjusting furniture support apparatus and a method of reconfiguring an item of furniture. The present invention also relates to securement apparatus for securing a support surface to furniture apparatus, an item of furniture comprising securement apparatus and furniture apparatus and a method of securing a support surface to furniture apparatus.

### BACKGROUND TO THE INVENTION

Furniture and, in particular, desks for information technology equipment, school furniture, office furniture and laboratory furniture generally comprises square or rectangular desks having a support leg at each corner thereof. Each leg has two support struts which extend perpendicularly to each other in order to support the desk surface. In certain situations, it may be required to have the desk arranged in a non-linear fashion, for example against an undulating wall. With conventional desks this may be unsightly due to the edges of the desks appearing to be haphazardly arranged. Similarly, when rooms, for example, computer rooms are rearranged, the new arrangement may require different shaped support surfaces. Accordingly, this requires new furniture to be purchased to fit the required shape.

In addition, if a desk is required to have a irregular shaped desk surface then a special frame must be built which is time consuming and expensive since it may only be required for a single situation or location. Alternatively, a standard square or rectangular support frame may be used which does not evenly or properly support the desk top and any items thereon.

Furniture for technology equipment, and in particular computers printers etc. generally have a number of wires associated therewith. Such wires are unsightly and can also be difficult correctly to identify which cable is which, for example in a large computer room or cyber cafe the number of wires may cause problems especially if the arrangement of the furniture is to be changed. In addition, in publicly accessible areas it is advantageous to hide and prevent access to any cables to prevent any misuse, either accidental or intentional, to the equipment.

It is an aim of the present invention to overcome at least one problem associated with the prior art whether referred to herein or otherwise.

### SUMMARY OF THE INVENTION

According to a first aspect of the present invention there is provided adjustable furniture support apparatus comprising a support leg, the support leg comprising retaining means in order to retain a support member such that the support member extends radially outwards from a longitudinal axis of the support leg, the retaining means being arranged to retain the support member at an adjustable angle about the longitudinal axis of the support leg.

Preferably, the support member is arranged, in use, to at least partially support a support surface.

The support member may have a tapered surface which is arranged, in use, to be urged against an oppositely tapered surface of the retaining means in order to secure or lock the support member to the support leg.

The retaining means may be arranged to retain the support member at a predetermined angle about the longitudinal axis of the support leg.

The retaining means may be arranged to retain the support member at predetermined angles about the longitudinal axis of the support leg.

The retaining means may be arranged to retain the support member in increments at predetermined angles about the longitudinal axis of the support leg. The increments, may be spaced at 15° increment about the longitudinal axis of the support leg.

The retaining means may comprise a series of retaining grooves to engage a retaining flange provided on the support member and preferably on a longitudinal end of the support member. The or each longitudinal end or longitudinal end face of the support member may be tapered inwardly from an upper end to a lower end. Accordingly, the width of the longitudinal end face may be greater at an upper portion compared to a lower portion. Preferably the longitudinal end or longitudinal end face comprises arcuately shaped sides. Preferably the sides of the longitudinal end or longitudinal end face are convex. The or each longitudinal end face of the support member may be arcuate and preferably is concave. The or each longitudinal end or longitudinal end face may comprise an inwardly curved cylindrical surface.

The retaining grooves may be tapered downwardly from an upper end to a lower end, for example the cross-section of the retaining grooves may decrease from an upper end to a lower end. The retaining range may be tapered downwardly from an upper end to a lower end, for example the cross-section of the retaining range may decrease from an upper end to a lower end. The retaining means preferably comprises a series of grooves which are spaced apart by an angled increment for example at 15° increments about the longitudinal axis of the support leg.

Each retaining groove preferably extends along a longitudinal direction of the support leg.

Preferably, the retaining means comprises a retaining collar which may be provided at or secured at an upper location on the support leg. Preferably the retaining collar provides an outer cylindrical surface which may be provided with the retaining grooves and the retaining collar thereby may have an outer generally cylindrical profiled surface.

Preferably each groove has a mouth portion and a retaining portion. Preferably the mouth portion prevents the retaining flange passing into or out of the groove in a first direction. The first direction may be a radial direction towards or away from the longitudinal axis of the support leg. The first direction preferably coincides with (or is in a parallel direction) the longitudinal axis of the support member. Preferably the retaining flange is inserted into the retaining groove by movement of the retaining groove in a second direction relative to the retaining flange. Preferably, the second direction is substantially perpendicular to the first direction. The second direction may be along the longitudinal direction (or a direction parallel to the longitudinal axis) of the support leg.

The retaining means may comprise a cover. The cover may be arranged to retain the retaining flange in the retaining groove in the second direction. Accordingly, once the retaining flange has been inserted into a retaining groove the cover plate may be position to prevent the retaining groove being removed in an opposite direction to the direction of its insertion. The cover may be secured in position by a securement element. The securement element may comprise a screw. The cover may be arranged to urge the retaining flange in a retaining groove.

Preferably the support member has a first retaining flange on a first longitudinal end and a second retaining flange on a second longitudinal end. Preferably the support member is arranged to extend between a first support leg and a second support leg.

Preferably the support surface is a desk or table top or work surface or the like.

The support member may provide a rail. The rail may enable securement means for support surface to be retained thereon. The securement means for a support surface may be movable or positionable along the rail to a selected position.

Preferably the support leg has a passageway defined therein and more preferably a passageway extending along the longitudinal direction of the support leg. The passageway may be arranged to enable a cable or cables to pass therethrough and, in particular, cables for information technology equipment and apparatus, for example computers, monitors, printers, internet and email access cables etc. The passageway may extend for substantially the full longitudinal length of the support leg.

The support leg may have a socket (or inlet socket) or a plurality of sockets provided thereon. The sockets may comprise a socket for a power cable and/or for information technology apparatus and equipment. The support leg may have a cable or a plurality of cables extending in the passageway from the socket to an outlet or to an outlet socket or a plurality of outlet sockets. The or each socket may have an operations switch associated therewith.

The support leg may have a foot at a first longitudinal end thereof. The foot may be adjustable to increase or decrease the overall longitudinal length of the support leg. The adjustable furniture support apparatus may be adjustable to support the support surface at a selected height.

The support leg may comprise a support base at a first longitudinal end thereof. The support base may enable the support surface to be supported by two support legs. The support base may enable the support leg to be capable of being a free standing unit. The support base preferably extends radially around the longitudinal axis of the support leg. The support base may extend around approximately 180° and preferably around less than 180° for example in the region of 135° to 170° around the longitudinal axis of the support let. The support base may be a substantially sector shape or may comprise a sector of cone.

The support base may extend substantially 360° around the longitudinal axis of the base. The base may be a substantially circular or conical shape.

The support leg may be supported on the ground by a or the support member. The support member may comprise a lever arm. The support member may be arranged to project from a lower end of the support leg and may be movable about the longitudinal axis of the support let. The support member may be arranged to locate underneath (but spaced from) a support surface. The support member may be secured to the support leg by retaining means.

The support leg may comprise upper retaining means and lower retaining means. The upper retaining means may be arranged, in use, to retain a support member for a support surface whilst the lower retaining means may b arranged to retain a support member for supporting the support leg on the ground.

The retaining means may be arranged to retain the support member at any angle (i.e. within 360°) about the longitudinal axis of the support leg.

The retaining means may be arranged to retain two support members to the support leg. The retaining means may be arranged to retain the two support members wherein the angle between the two support members is adjustable to define any angle therebetween.

The support member may comprise an annular member. The annular member may be arranged to locate around the retaining member. The annular member may be secured to or integral with the support member.

The retaining member may comprise a boss and preferably a boss that is tapered outwardly from an upper end to a lower end.

The annular member may comprise an inner surface which is tapered outwardly from an upper end to a lower end.

The boss may be arranged to retain a first support member and a second support member. The first support member may comprise a lower annular member whilst the second support member may comprise an upper annular member.

Preferably, in use, the upper annular member and the lower annular member are located on the boss and the upper annular member locates directly above the lower annular member.

A cover may be arranged to urge the upper annular member and/or the lower annular member downwardly to urge the tapered retaining surface of the or each annular member against the tapered retaining surface of the boss. The cover may be releasable (but not necessarily removed from the support leg) to enable the annular member and hence the support member to rotate about the longitudinal axis of the support leg.

The boss may comprise a frusto-conical member. The inner surface of the or each annular member may be substantially frusto-conical.

The or each annular member may comprise a cylindrical member and may provide an outer cylindrical surface.

According to a second aspect of the present invention there is provided an item of furniture comprising at least one support leg, the support leg comprising retaining means to retain a support member thereto such that the support member extends radially away from a longitudinal axis of the support leg, the retaining means being arranged to retain the support member at an adjustable angle about the longitudinal axis of the support leg.

Preferably, the support member is arranged, in use, to at least partially support a support surface.

The item of furniture may comprise a first support leg and a second support leg. The first support leg may be arranged to retain the longitudinal end of the support member whilst the second support leg may be arranged to retain a second longitudinal end of the support member.

According to a third aspect of the present invention there is provided a method of adjusting furniture support apparatus, the method comprising retaining a support member to a support leg by retaining means such that the support member extends radially away from a longitudinal axis of the support leg, the method further comprising retaining the support member at a selected angle about the longitudinal axis of the support leg.

Preferably the method comprises at least partially supporting a support surface on to the support member.

The method may comprise adjusting the angle of the support member about the longitudinal axis of the support leg.

According to a fourth aspect there is provided a method of reconfiguring an item of furniture, the item of furniture comprising at least one support leg, a support surface and a support member the support leg comprising retaining means in order to retain the support member such that the support member extends radially outwards from a longitudinal axis of the support leg, the method comprising supporting the support member at a different angle about the longitudinal axis of the support leg.

For at least partially supporting the support surface thereon.

The method may comprise providing a first item of furniture having a first support surface of a first shape and reconfiguring the item of furniture to provide a second item of furniture having a second support surface of a second shape.

According to fifth aspect of the present invention there is provided securement apparatus for securing a support surface to furniture apparatus, the securement apparatus comprising support means which is arranged, in use, to support the support surface, the support apparatus comprising an engagement portion which is arranged, in use, to locate within an opening provided by the furniture apparatus, the engagement portion being arrangeable to move from a first position to a second position whilst the engagement portion is located within the opening, the securement apparatus further comprising a securement portion which is arranged to couple the support surface to the engagement portion, wherein the support surface is secured to the furniture apparatus when the engagement portion is in the second position.

The engagement portion may be arranged to move from a second position to a first position whilst inserting the engagement portion into the opening and then may be arranged to move towards the second position to retain at least a part of the securement apparatus to the furniture apparatus.

The opening may comprise a retaining groove.

Preferably the engagement portion is biased towards the second position. The engagement portion may be arranged to be moved from the second position to the first position by abutment with a surface of the opening.

The opening may comprise a recessed portion extending upwardly in the opening. Preferably the engagement portion is arranged to project into the recessed portion, in use. Preferably the engagement portion moves from the first position to the second position to project into the recessed portion.

The securement apparatus may comprise a securement member and a retaining member. The support surface may be arranged to be supported on a surface of the securement member. The surface of the securement member may have a raised portion provided thereon. The raised portion may be arranged to project into a recess provided on a lower surface of the support surface. The raised portion may comprise a discrete raised portion or a peg. The raised portion may comprise an elongate raised portion or a rib.

The securement member may be arranged, in use, to be secured to the support surface and preferably to a lower surface of the support surface. The securement member may be arranged to be adhered to the support surface and preferably prior to locating the securement member adjacent to the retaining member.

The retaining member may have an abutment portion which is arranged to abut a surface of the support member and preferably is arranged to abut an upper surface of the support member.

The retaining member may comprise a co-operating portion which is arranged in use to locate within the opening or retaining groove of the support member.

The engagement portion may be provided on the retaining member.

The engagement portion may be movable relative to the abutment portion. The engagement portion may be movable relative to the co-operating portion.

The engagement portion may be provided on an engagement arm and preferably on an end of the engagement arm.

The engagement arm may be movable relative to the abutment portion.

The engagement arm preferably comprises a resilient portion.

The engagement arm may comprise a resilient material.

Preferably the retaining member is arranged, in use, to be located adjacent to the securement member. The securement member may comprise a co-operating member to engage with the retaining member.

Preferably the securement member provides a securement or locking surface which engages with a securement or locking surface of the co-operating portion and or engagement arm (or retaining member) in order to retain the support surface to the furniture apparatus.

The locking surface of the securement member may be provided on a locking arm. The locking arm and/or locking surface may be arranged to move from a first position to a second position as the securement member is located adjacent to the retaining member. The locking arm and/or locking surface may be arranged to move from the second position to the first position in order to provide a locked configuration. The locking surface may be provided on a locking tooth. The locking surface and/or locking arm may be biased towards the first position.

The opening may comprise a recessed portion extending upwardly in the opening. Preferably the engagement portion is arranged, in use, to project into the recessed portion, in use.

According to a sixth aspect of the present invention there is provided an item of furniture comprising securement apparatus for securing a support surface to furniture apparatus in accordance with the fifth aspect of the present invention, the item of furniture further comprising a support surface.

The furniture apparatus may comprise adjustable furniture support apparatus in accordance with the first aspect of the present invention.

The item of furniture may be in accordance with the second aspect of the present invention.

According to a seventh aspect of the present invention there is provided a method of securing a securement apparatus to furniture apparatus comprising locating an engagement portion of securement apparatus in an opening provided by the furniture apparatus, the method further comprising moving the engagement portion from a first position to a second position whilst the engagement portion is located in the opening wherein the securement apparatus is secured to the furniture apparatus when the engagement portion is in the second position and the engagement portion is insertable into the opening when the engagement portion is in the first position.

Preferably the method comprises retaining or locking the engagement portion in the second position, once in the opening, using a securement member.

The method may comprise supporting a support surface on the securement apparatus. The method may comprise supporting a support surface on the securement member.

The engagement portion may be provided on a retaining member.

The method may comprise securing a securement member to the underside of the support surface. The method may comprise locking the securement member adjacent to the retaining member in order to secure or lock the engagement portion in the second position.

### BRIEF DESCRIPTION OF THE DRAWINGS

The present invention will now be described, by way of example only, with reference to the drawings that follow, in which:

FIG. 1 is an exploded perspective view of an embodiment of adjustable furniture support apparatus.

FIG. 2 is a plan view of an embodiment of part of adjustable furniture support apparatus.

FIG. 3 is an exploded perspective view of an embodiment of an item of furniture comprising adjustable furniture support apparatus.

FIG. 4 is a perspective view of an embodiment of an item of furniture comprising adjustable furniture support apparatus.

FIG. 5 is a perspective view of an embodiment of an assembly of items of furniture comprising adjustable furniture support apparatus.

FIG. 6 is a perspective view of an embodiment of an support surface.

FIG. 7 is a perspective view of an embodiment of a frame for an item of furniture.

FIG. 8 is a partially exploded perspective view of another embodiment of adjustable furniture support apparatus.

FIG. 9 is a perspective view of another embodiment of an assembly comprising items of furniture comprising adjustable furniture support apparatus.

FIG. 10 is a plan view of an further embodiment of items of furniture comprising adjustable furniture support apparatus.

FIG. 11 is a perspective view of a further embodiment of adjustable furniture support apparatus.

FIG. 12 is an exploded perspective view of a yet further embodiment of adjustable furniture support apparatus.

FIG. 13 is a perspective view of a yet further embodiment of adjustable furniture support apparatus.

FIG. 14 is a plan schematic view of a yet further embodiment of adjustable furniture support apparatus.

FIG. 15 is a perspective exploded view of an embodiment of securement apparatus for a support surface together with part of an embodiment of an item of furniture.

FIG. 16a is a cross-section of an embodiment of securement apparatus for a support surface.

FIG. 16b is a perspective cut away view of an embodiment of securement apparatus for a support surface.

FIG. 17 is a perspective cut-away view of a preferred embodiment of a retaining member.

FIGS. 18 to 21 show a perspective view of a preferred embodiment of a support member being retained to a preferred embodiment of a retaining member.

FIG. 21a is an end view of a preferred embodiment of a longitudinal end face of a support member.

FIG. 22 is a front view of a yet further embodiment of adjustable furniture support apparatus.

FIG. 23 is a side view of an alternative embodiment of an item of furniture.

### DESCRIPTION OF THE PREFERRED EMBODIMENTS

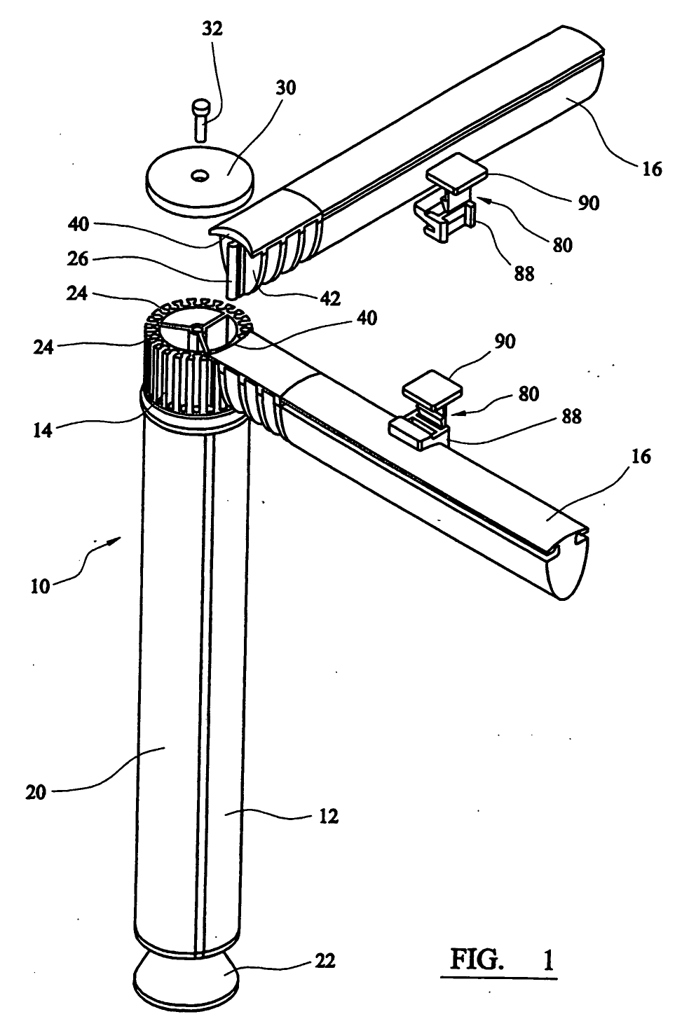

As shown in FIG. 1, adjustable furniture support apparatus 10 comprises a support leg 12 and retaining means in the form of a retaining member 14 which is arranged to retain a support member 16 to the support leg 12. The support member 16 is arranged to extend radially away from the longitudinal axis of the support leg 12 and the support leg 12 is arranged, in use, to be in a substantially vertical plane whilst the support member 16 is arranged to be in a substantially horizontal plane. Accordingly, the support member 16 is substantially perpendicular to the support leg 12. The support leg 12 has a foot 22 provided at the lower end thereof to be supported on the floor or ground. The foot 22 may be adjustable and can be screwed into or out of the support leg 12 in order for the height of the support leg 12 to be adjusted.

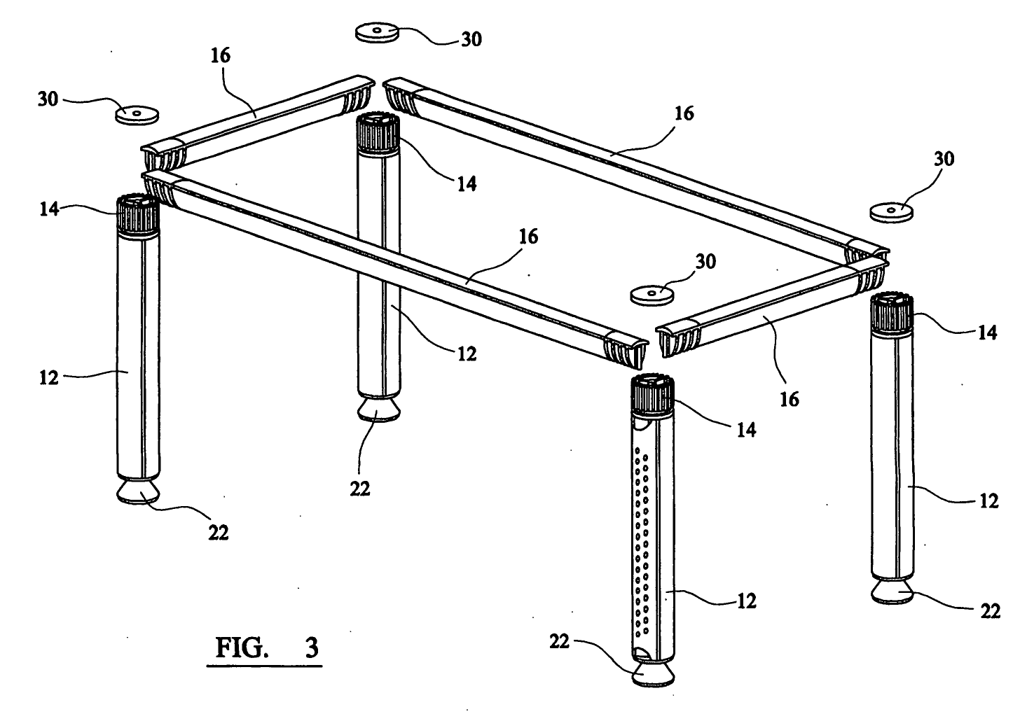

As shown in FIG. 3 and FIG. 4, an item of furniture, for example a desk 18 or table, comprises a number of support legs 12 and support members 16. Each support leg 12 retains and support two support members 16. Each support member 16 extends from a first support leg 12 to a second support leg 12. Accordingly, the item of furniture includes four support legs 12 and four support members 16.

As shown in FIG. 4, the support members 16 are arranged to support a support surface 19 thereon. The support surface 19 (as shown in FIG. 6) may simply be rested on the support members 16 but preferably securement apparatus 80 for the support surface 19 is preferably used. The securement apparatus 80 will be described in more detail later.

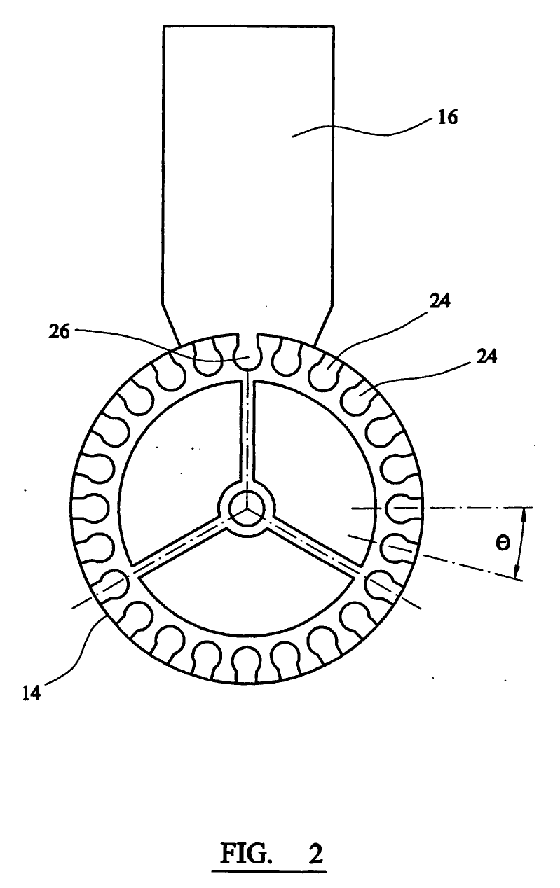

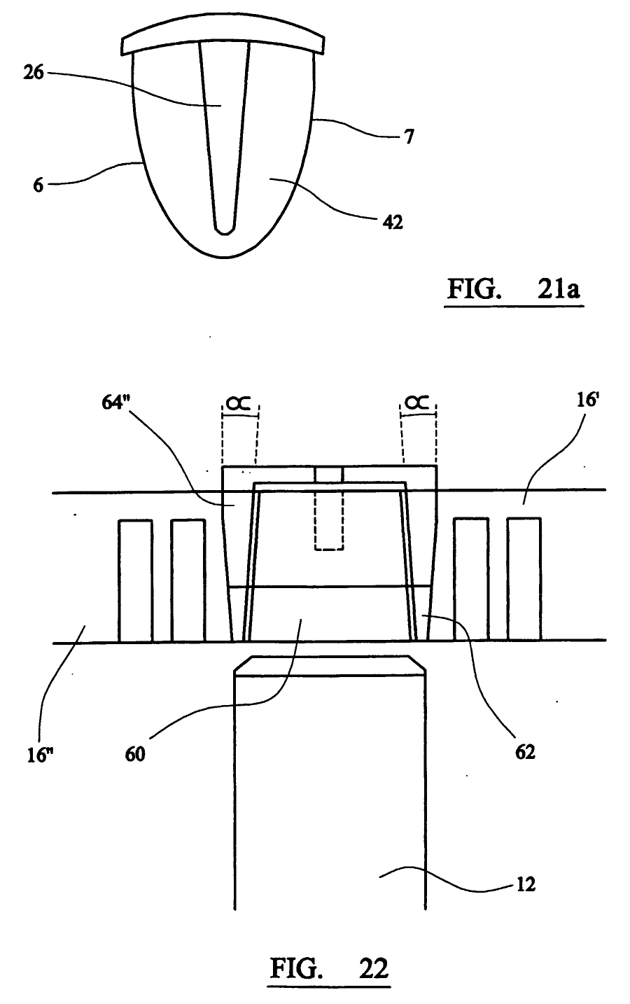

As shown in FIG. 1, FIG. 2 and FIG. 17 to 21, the retaining member 14 comprises a collar secured at an upper end of the support leg 12. The collar may be a discrete member which is secured to the leg. The collar has an outer surface which is generally cylindrical. The outer surface has a plurality of retaining grooves 24 provided thereon. Accordingly, the outer surface comprises a profiled or keyed surface. The grooves are spaced around the periphery of the collar and are spaced at angled increments, θ and preferably at 15° increments.

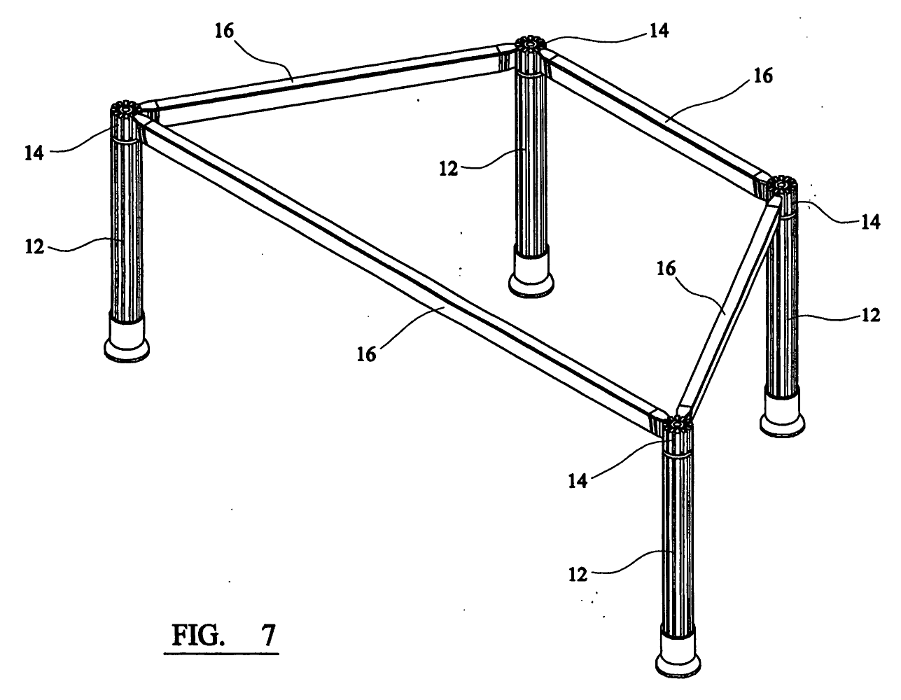

The support member 16 has a retaining flange 26 defined at a longitudinal end thereof. The retaining flange 26 is arranged, in use, to locate with a retaining groove 24 of the collar in order to retain the support member 16 to the support let at a selected angle about the longitudinal axis of the support leg 12. Accordingly, the retaining member 14 enables the support member 16 to be retained to the support leg 12 at a selected an adjustable angle about the longitudinal axis of the support leg 12. Since the retaining grooves 24 are provided at 15° increments, this enables two or more support members 16 to be retained at a selected angle relative to each other, although this angle may be dictated by the increments. The 15° incremented grooves enables the popular and frequent angle of 90° to be easily achieved whilst also enabling other popular angle such as 30°, 45°, 60°, 180° etc and all other multiples of 15°. Accordingly, the adjustable furniture support apparatus 10 can be used to support difficult shaped support surfaces 19 and to create different shaped desks etc. For example, regular polygon shaped desks irregular polygon shaped desks, (as shown in FIG. 7) square, rectangular, triangles, pentagon, hexagon, octagon, etc, shaped desks and also other trapezoidal shaped desks.

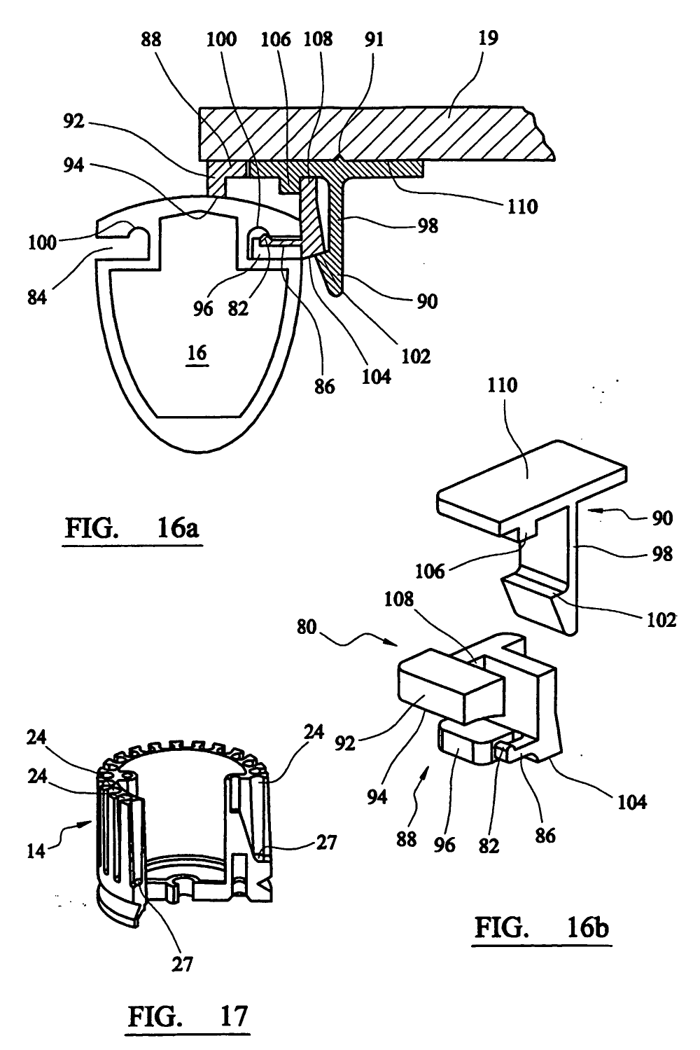

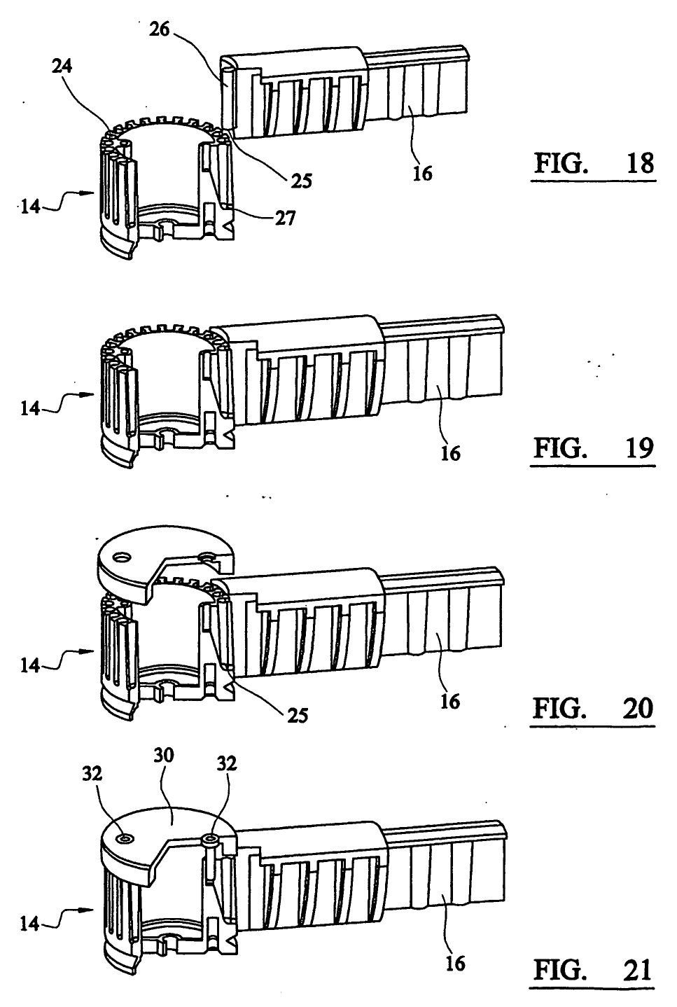

The retaining grooves 24 are shaped to prevent removal of the retaining flange 26 from the retaining groove 24 and in particular the prevent movement of the support member 16 along the longitudinal direction of the support member 16. The retaining flange 26 is inserted into the retaining groove 24 by locating the retaining flange 26 above the retaining groove 24 and then sliding the support member 16 and hence the retaining flanges 26 into the retaining groove 24. This movement is along the longitudinal direction of the support leg 12 and also the longitudinal direction of the retaining groove 24 and the retaining flange 26. The shape of the retaining groove 24 and the co-operating shape of the retaining flange 26 thereby prevents the retaining flange 26 from being removed from the retaining groove 24 by pulling the support member 16 along its longitudinal axis. Each retaining groove 24 has a retaining portion and a mouth portion with the retaining portion retaining the retaining flange 26 therein whilst the mouth portion preventing the retaining flange 26 passing through the mouth portion. Similarly, the retaining flange 26 comprises a retaining portion and a neck portion. The securement of the retaining flange 26 in a retaining groove 24 is shown in FIGS. 18 to 21.

The retaining grooves 24 are tapered from the upper end to the lower end as shown in FIG. 17. Similarly, the retaining flange 26 is tapered from an upper end to a lower end as shown in FIG. 18. Accordingly, as the retaining flange 26 is moved downwardly the retaining groove 24 securely grips or retains the retaining flange 26. The tapered retaining flange 26 and tapered retaining groove 24, once assembled, prevent or inhibit relative movement therebetween and especially in directions not along the longitudinal direction of the support leg 12. This results in the join being secure and without rocking movement which may be present in conventional furniture joins. Conventional furniture joins may rely on the manufacturing tolerances between the joins which may be expensive to prevent rocking or the furniture may be cheap and thereby is at risk from rocking. The tapered flange 26 may also have a projection 25 at the lower end thereof to locate in a recess 27 at the bottom of the tapered groove 24 in a fully interlocked position.

The retaining flange 26 can only be removed from the retaining groove 24 by reversing the insertion movement i.e. moving the retaining flange 26 upwards relative to the retaining groove 24.

The retaining means comprises a plate or cover 30 which is arranged to be located over the upper surface of the retaining member 14. The cover 30 thereby prevents the retaining flanges 26 from being removed from the retaining groove 24.

The cover 30 is secured to the retaining member 14 by a securement element 32 or elements in the form of a screw(s) or bolt(s). The cover 30 is circular and is arranged to co-operate with an upper end edge or the longitudinal end of the support member 16, for example the upper end edge 40 of the support member 16 may be arcuate. Accordingly, this conceals any gap and creates a good join. As the cover is screwed or otherwise urged downwardly on to the upper end of the support leg the tapered flanges 26 are urged into the tapered groove 24 to provide a secure join.

Furthermore, a first longitudinal end of the support member 16 has an arcuate or cylindrical end surface 42 to co-operate with the outer surface of the retaining member 14 as shown in FIG. 2. The longitudinal end(s) or longitudinal end face(s) 42 are tapered inwardly from an upper end to a lower end as shown in FIG. 1, FIG. 3 FIG. 7 and FIG. 17 to FIG. 21a. The sides 6, 7 of the longitudinal end faces 42 are curved and more particularly are convex. This shape further provides a strong join between the support member and the support leg. In addition, the support member 16 itself is tapered along the longitudinal extent thereof towards the longitudinal end, as shown in FIG. 2.

The retaining portion of the retaining flange 26 is generally circular or cylindrical and is tapered from an upper end to a lower end. Similarly, the retaining portion of the retaining groove 24 is generally cylindrical or circular in cross-section. As previously explained, the retaining flange 26 and the retaining groove 24 are both tapered.

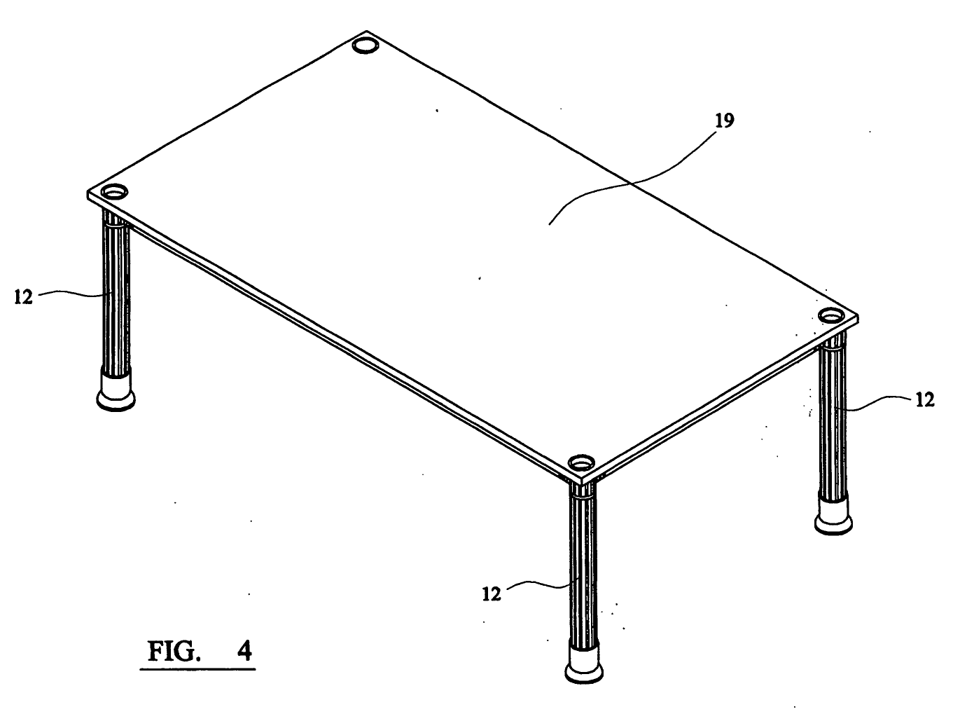

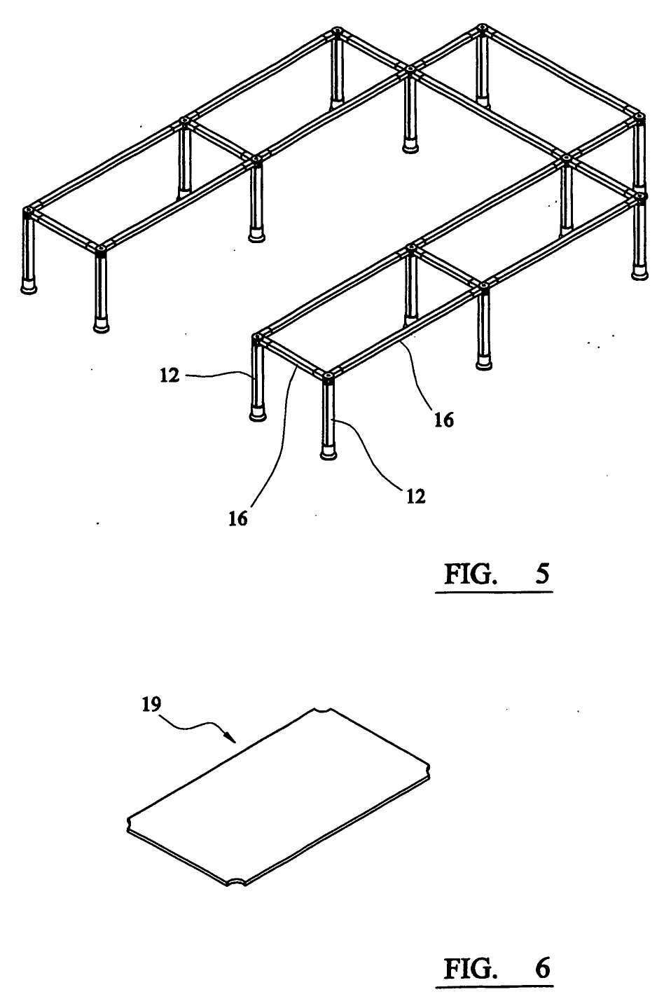

Since the retaining member 14 enables a plurality of support members 16 to be retained therefrom, each leg may be arranged to support more than one support surface 19, as shown in FIG. 5. For example, if two desks 18 are to be placed adjacent to each other, rather than each desk 18 having a full set of four legs, where the desks 18 are adjacent, a single leg could be used in order to retain support members 16 for more than one desk 18. Accordingly, this substantially reduces the amount of equipment required and thereby reduces the cost. Similarly, each support member 16 may be arranged to support two adjacent support surfaces, as shown in FIG. 5.

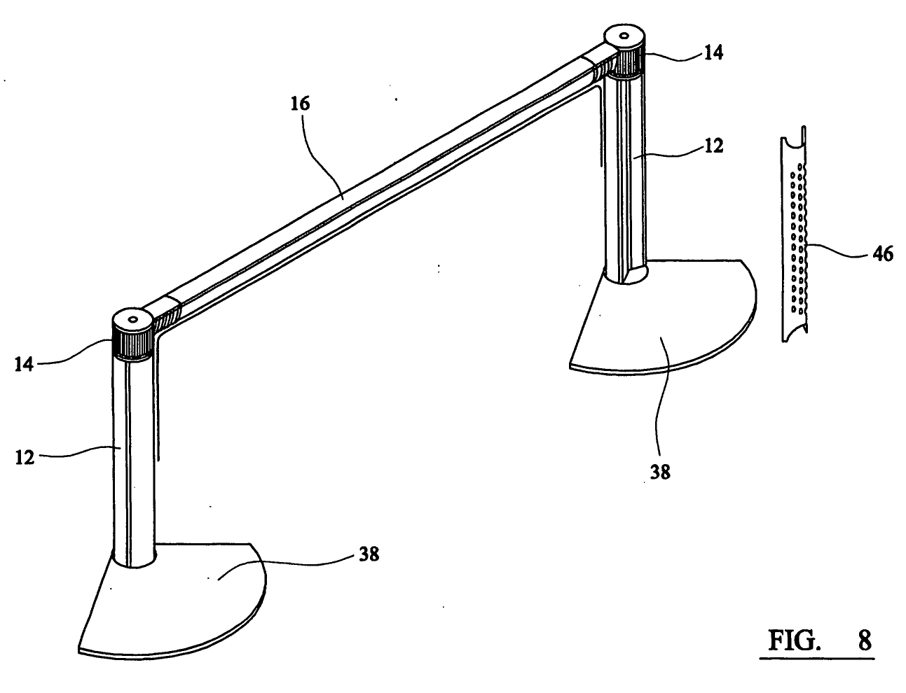

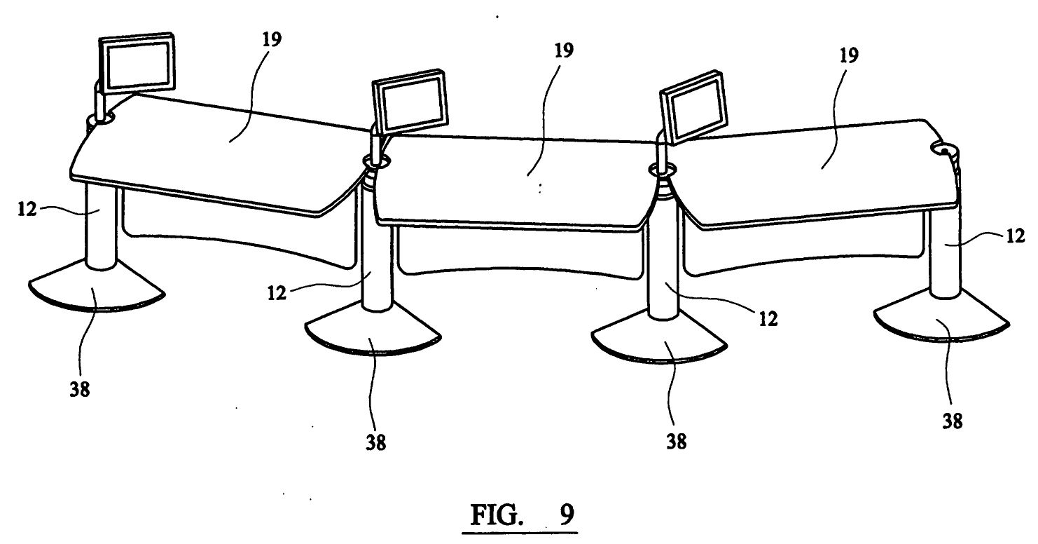

As shown in FIG. 8 and FIG. 9, the support leg 12 may be provided with a base 38. The base 38 is arranged to support the support leg 12 on the floor and may enable the support leg 12 to be a free standing unit. The base 38 extends radially around the longitudinal axis of the support leg 12.

The base 38 may extend through between 135° and 170° around the longitudinal axis of the support leg 12.

In an alternative embodiment, the base 38 may be arranged to provide a free standing leg in order to support a support surface 19 thereon, i.e. a single support leg 12 may be arranged to support the support surface 19. The retaining member 14 of the support leg 12 may be arranged to have a number, for example three or four support members 16 extending outwardly (e.g. radially outwardly), therefrom. This arrangement may be arranged to provide a pedestal table. Accordingly, the base may extend the full 360° around the longitudinal axis of the support leg 12.

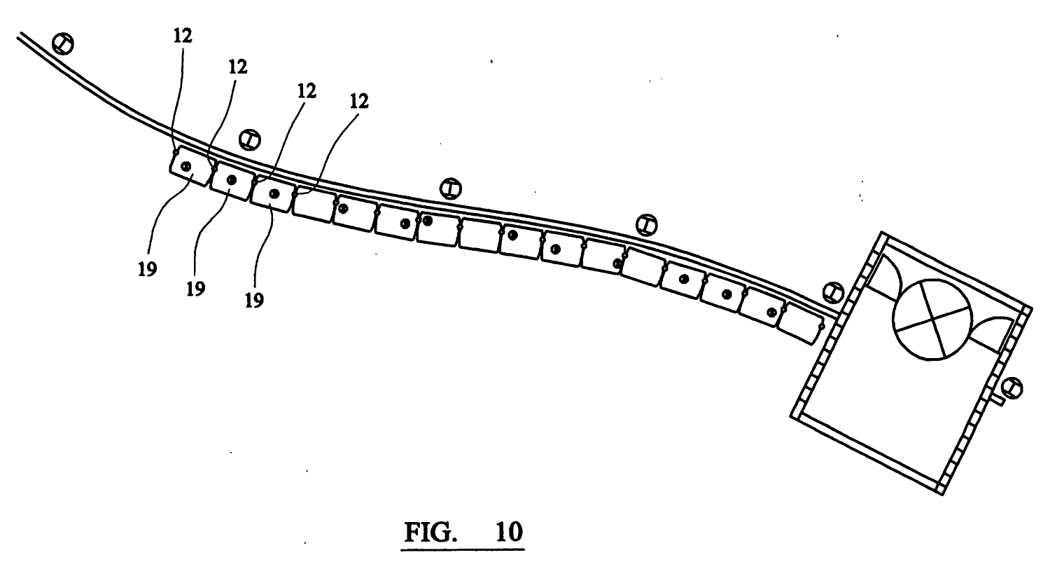

As shown in FIG. 9. FIG. 10 and FIG. 11, the support leg 12 may be arranges to support a monitor directly thereon and also to support a support surface 19. Two support legs 12 may be arranged to support the support surface 19 therebetween. Since only two support legs 12 are used, with each support leg 12 supporting two support members at generally 180° relative to each other (not shown) this provides economic and space saving furniture. In addition, a row of desks can be arranged to be non-linear, for example to be aligned with a non-linear wall and in particular may provide a row of desks and monitors for use in a cyber cafe or computer room.

The support leg 12 has a passageway defined therethrough which preferably extends through the longitudinal length of the support leg 12. The passageway may enable cables to pass therethrough and, in particular, enables cables for information technology equipment to pass therethrough, for example cables for computer, printers and monitors etc. In addition, the support leg 12 may have a socket 44 or sockets to enable external cables to be plugged in, as shown in FIG. 11. An internal cable may be provided which may extend through the passageway to the upper end or desk 18 surface or to another socket. The support leg 12 may have an actuating switch 46 associated with the or each socket in order to turn the socket on or off. In addition, the support leg 12 may have a removable and replaceable cover 46 to provide access to the passageway through the support leg 12 as shown in FIG. 8.

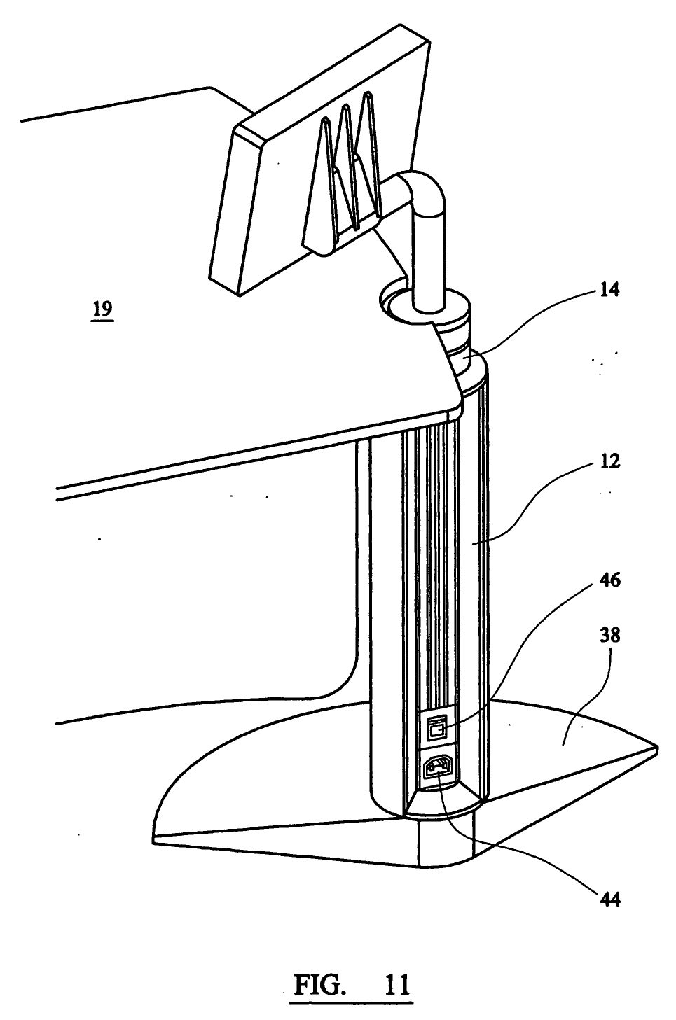

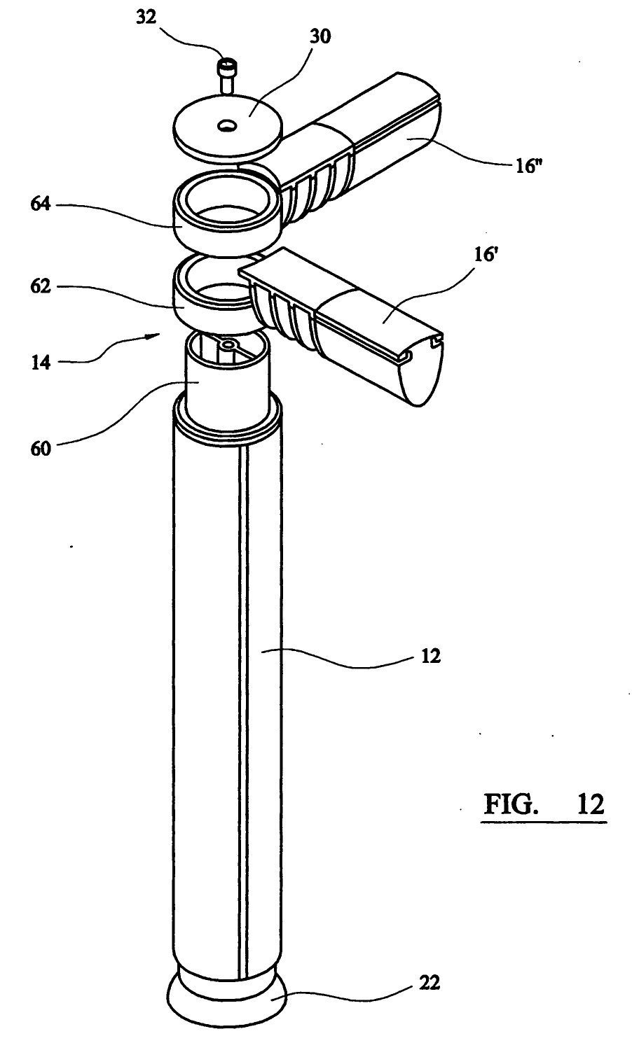

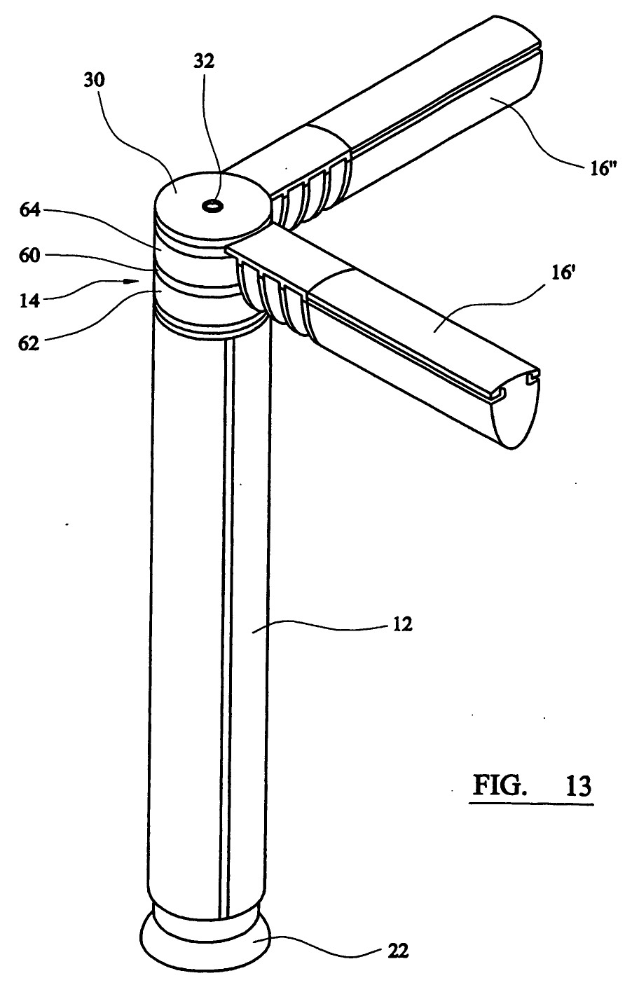

As shown in FIGS. 12 to 14 and FIG. 22, the retaining member may comprise two annular (or cylindrical) members 62, 64. The support member 16 has an annular member 62 or 64 secured thereto, for example, the annular member 62 or 64 may be integral with the support member 16. A first support member 16′ may have a lower annular member 62 secured thereto whilst a second support member 16″ may have an upper annular member 64 secured thereto.

The lower annular member 62 is arranged to locate over a retaining surface provided by a boss 60. The boss 60 provides an outer generally cylindrical retaining surface. The retaining surface is tapered outwardly from the upper end thereof, i.e. the cross-section of the boss extends outwardly from the upper end to the lower end. Similarly, each annular member 62, 64 has an inner retaining surface which is tapered outwardly from an upper end to a lower end. In particular, the retaining surfaces of the boss and the annular members 62, 64 are arranged at an angle, a, which may be in the region of 1-5° and preferably is substantially 1.5°.

In use, the lower annular member 62 is located over the boss in order to support a first support member 16′ at an angle about the longitudinal axis of the support leg 12. The upper annular member 64 is then located over the boss in order to support a second support member 16″ at an angle about the longitudinal axis of the support leg 12. The first support member 16′ can then be rotated, about the longitudinal axis of the support leg, relative to the second support member 16″ in order for the first support member 16′ to be located at any predetermined angle relative to the second support member 16″.

A cover 30 is located on to the upper end of the boss 60 and is secured thereto by a securement element 32. The securement element 32 is arranged to urge the cover 30 downwards which thereby urges the upper annular member 64 and the lower annular member 62 downwards. This forces the retaining surface of the annular members 62, 64 to abut and to be urged against the retaining surface of the boss 60. This prevents the support members 16′, 16″ from being rotated about the boss 60 and therefore locks the support members 16′, 16″ in position.

In order to adjust or reconfigure the furniture, the securement element 32 can be loosened to enable the first support member 16′ and the second support member 16″ to be rotated about the boss 60 to another relative angle to provide support means for a support surface 19. Accordingly, this embodiment enables the support members 16′, 16″ to be at any angle relative to each other.

In alternative embodiments, the boss 60 may be arranged to support one or more than two (for example four) annular members in order to support the corresponding number of support members.

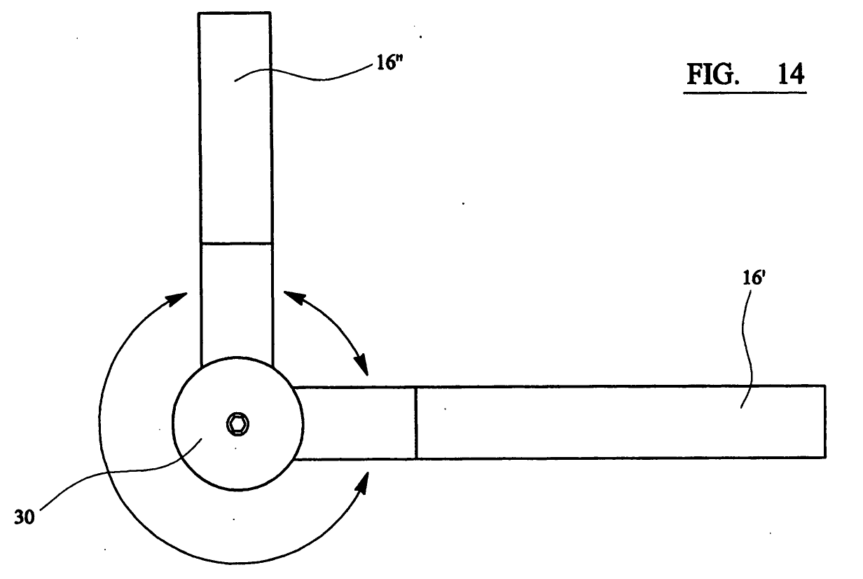

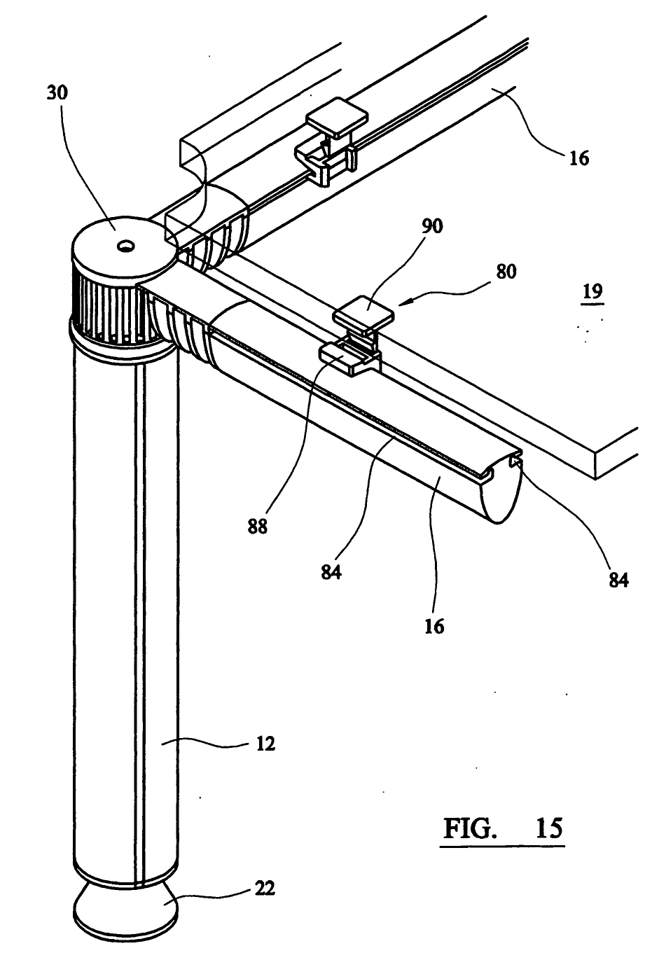

As shown in FIGS. 1, 15 and 16, securement apparatus 80 for a support surface 19 comprises an engagement portion 82 which is arranged to locate in an opening or engagement groove 84 provided along the support member 16. Accordingly, the support member 16 provides a support rail. The engagement portion 82 is provided on an engagement arm 86.

The securement apparatus 80 comprises a retaining member 88 and a securement member 90. The retaining member 88 provides a housing or surface in order for the securement member 90 to locate adjacent thereto.

In use, the engagement portion 82 is located in the groove 84. In performing this, the engagement portion 82 is flexed downwards whilst being pushed into the retaining groove. Once in the specified position in the groove 84, the engagement portion 82 flexes upwardly to locate in a recessed portion 100 in the groove 84.

An abutment surface 92 of the retaining member 88 abuts and locates on the upper surface 94 of the support member 16. A co-operating portion 96 of the retaining member 88 also locates in the groove 84. As the securement member 90 is located into the housing or surface provided (for example a shaped surface) in the retaining member 88, a securement or locking arm 98 secures or locks the securement member 90 to the retaining member 88 and hence to the support member 16. The securement member 90 comprises a co-operating member 106 which interlocks with an interlocking portion 108 provided on the retaining member to help to retain the securement member 90 adjacent to the retaining member 88.

As can be seen in FIG. 16, the groove 84 comprises a recessed portion 100. The engagement portion 82 is moved into the recessed portion 100 in the secured position. This thereby prevents the engagement portion 82 from being removed from the groove 84 and hence the securement apparatus 80 is secured to the support member 16. In the fully secured position, a locking surface 102 on the securement member 90 or locking arm 98 engages with a locking surface 104 on the engagement arm 86.

The securement member 90 is secured to the lower surface of the support surface 19, for example by adhesive means which may comprise an adhesive tape or glue. The securement member 90 is secured to the support surface 19 prior to the locating the securement member 90 adjacent to the retaining member 88. In use, a plurality of securement members 90 are secured to the underside of the support surface 19 at predetermined locations. Corresponding retaining members 88 are then secured into the grooves 84 provided by the support members 16 for the support surface 19. The support surface is then lowered on to the support members 16 in order for the securement members 90 to be secured to the retaining members 88 which are already secured to the support members 16.

The support surface 19 is locked to the support members 16 since the securement or locking surface 102 of the securement member 90 engages the locking surface 104 on the retaining member 88.

The securement apparatus 80 may act in pairs in order for one securement apparatus to secure one edge of the support surface 19 whilst the second support apparatus secures a second opposite edge of the support surface 19.

The securement member 90 provides a support surface 110 in order to support the support surface 19 of the desk 18. Alternatively or additionally, the retaining member 88 may also provide a support surface. The support surface of the securement member 90 may have a projecting portion 91 in order to project into a recess provided in the lower surface of the support surface 19. This may provide alignment means to enable the locking members 90 to be correctly positioned relative to the outer edge of the support surface 19 in order for the locking surface 102 of the securement member 90 to be correctly positioned relative to the locking surface 104 of the retaining member 88.

The groove 84 extends along the longitudinal length of the support member 16 and, therefore the securement apparatus 80 can be located at any position along the length thereof. The engagement portion 82 is provided on a resilient member (for example an engagement arm 86) in order for the engagement portion 82 to be movable, for example to flex down whilst being inserted into the groove and then to flex up into the recessed portion 100. The engagement arm 86 and engagement portion 82 move downwardly relative to the co-operating portion whilst being inserted into the groove and then naturally flexes upwardly to project into the recessed portion 100.

In addition, each support member 16 provides two grooves along both lateral sides and, therefore, a single support member 16 can be used to support a support surface 19 at either side thereof.

The engagement arm 86 comprises a resilient portion and preferably comprises a resilient material. The engagement arm 86 is biased towards the second (or secured) position and, therefore the engagement portion 82 is flexed down by a wall of the opening or groove 84 whilst being inserted into the groove 84 and then flexes upwardly naturally to project into the recessed portion 100. The co-operating portion 96 acts as a guide whilst the engagement portion 82 is being inserted and, in the second position, the co-operating position abuts the lower surface of the groove 84 whilst the engagement portion 82 projects with the recessed portion in order to secure the securement apparatus 80 to the support member 16.

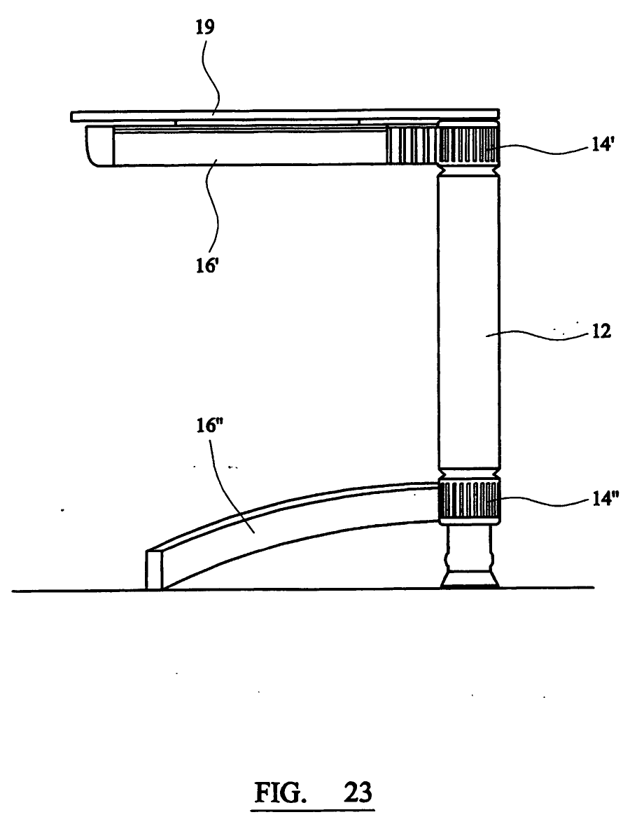

As shown in FIG. 23, in an alternative embodiment, the support leg 12 may be arranged in a cantilever arrangement and in particular for the support legs 12 to be located towards the rear edge of the support surface 19. For example, when two desks are adjacent to each other a person working at the desk can simply and quickly move to the adjacent desk and the support legs 12 will not obstruct this movement and, in particular, a person in a chair with wheels can simply wheel themselves to the adjacent desk without moving away from the desks.

The support leg 12 comprises a lower support member 16″ or lever arm 16″ which is arranged to project radially away from the support leg 12 at a lower position. The lever arm 16″ extends from the support leg 12 and locates underneath the support surface 19 in order to support the support surface 19. The lever arm 16″ locates below the support member 16″.

The lever arm 16″ projects or extends away from the support leg 12 and is angled downwardly in order to abut and engage the ground at a location spaced from the support leg 12. Accordingly, the forces acting on the support surface 19 are transferred through the support leg 12 and are transferred to the ground by the lever arm 16″. For example the foot 22 of the support leg may act as a pivot on the ground with the lever arm preventing rotation about the foot 22.

The lever arm 16″ is secured to the support leg 12 by a lower retaining member 14″. Accordingly, the lever arm can be arranged to project outwardly from the support leg 12 at an adjustable angle. For example, if the item of furniture is reconfigured and the size or shape of the support surface 19 is altered (and for example if the position of the upper support member 16″ is changed) then the location and position of the lever arm 16″ can similarly be changed. Preferably the lower retaining member 14″ is spaced from the floor by a foot portion.

The lever arm 16″ may comprise a substantially arcuate member. It is appreciated that all embodiments of the retaining member may be used to secure the lever arm 14″ to the support leg 12.

The lever arm 16″ does not require the groove or rail as previously described on the earlier embodiments of the support member 16.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. Adjustable furniture support apparatus comprising a support leg, the support leg comprising retaining means in order to retain a support member such that the support member extends radially outwards from a longitudinal axis of the support leg, the retaining means being arranged to retain the support member at an adjustable angle about the longitudinal axis of the support leg.

2. Adjustable furniture support apparatus according to claim 1 in which the support member is arranged, in use, to at least partially support a support surface.

3. Adjustable furniture support apparatus according to claim 1 in which the support member has a tapered surface which is arranged, in use, to be urged against an oppositely tapered surface of the retaining means in order to secure the support member to the support leg.

4. Adjustable furniture support apparatus according to claim 1 in which the retaining means is arranged to retain the support member at a predetermined angle about the longitudinal axis of the support leg.

5. Adjustable furniture support apparatus according to claim 4 in which the retaining means is arranged to retain the support member in increments at predetermined angles about the longitudinal axis of the support leg.

6. Adjustable furniture support apparatus according to claim 1 in which the retaining means comprise a series of retaining grooves to engage a retaining flange provided on the support member.

7. Adjustable furniture support apparatus according to claim 6 in which the retaining grooves are tapered downwardly from an upper end.

8. Adjustable furniture support apparatus according to claim 6 in which the retaining flange is tapered downwardly from an upper end to a lower end.

9. Adjustable furniture support apparatus according to claim 6 in which each retaining groove extends along a longitudinal direction of the support leg.

10. Adjustable furniture support apparatus according to claim 6 in which each groove has a mouth portion and a retaining portion.

11. Adjustable furniture support apparatus according to claim 10 in which the mouth portion prevents the retaining flange passing into or out of the groove in a radial direction towards or away from the longitudinal axis of the support leg.

12. Adjustable furniture support apparatus according to claim 6 in which the retaining means comprises a cover.

13. Adjustable furniture support apparatus according to claim 12 in which the cover is arranged to retain the retaining flange in the retaining groove in a second direction.

14. Adjustable furniture support apparatus according to claim 12 in which once the retaining flange has been inserted into a retaining groove the cover plate is positioned to prevent the retaining groove being removed in an opposite direction to the direction of its insertion.

15. Adjustable furniture support apparatus according to claim 1 in which the support member has a first retaining flange on a first longitudinal end and a second retaining flange on a second longitudinal end.

16. Adjustable furniture support apparatus according to claim 15 in which an or each longitudinal end face of the support member is tapered inwardly from an upper portion to a lower portion.

17. Adjustable furniture support apparatus according to claim 15 in which an or each side of an or each longitudinal end face of the support member is arcuate or convex.

18. Adjustable furniture support apparatus according to claim 1 in which the support member is arranged to extend between a first support leg and a second support leg.

19. Adjustable furniture support apparatus according to claim 1 in which the support member is arranged, in use to support a support surface wherein the support surface is a desk or table top or work surface or the like.

20. Adjustable furniture support apparatus according to claim 1 in which the support member provides a rail.

21. Adjustable furniture support apparatus according to claim 20 in which a securement means for a support surface is movable along the rail to a selection position.

22. Adjustable furniture support apparatus according to claim 1 in which the support leg has a passageway defined therein.

23. Adjustable furniture support apparatus according to claim 22 in which the passageway is arranged to enable a cable to pass therethrough.

24. Adjustable furniture support apparatus according to claim 1 in which the support leg has a socket for a power cable and/or for information technology apparatus and equipment.

25. Adjustable furniture support apparatus according to claim 1 in which the support leg has a foot at a first longitudinal end thereof.

26. Adjustable furniture support apparatus according to claim 25 in which the foot is adjustable to increase or decrease the overall longitudinal length of the support leg.

27. Adjustable furniture support apparatus according to claim 1 in which the adjustable furniture support apparatus is adjustable to support a support surface at a selected height.

28. Adjustable furniture support apparatus according to claim 1 in which the retaining means is arranged to retain the support member at any angle about the longitudinal axis of the support leg.

29. Adjustable furniture support apparatus according to claim 1 in which the retaining means is arranged to retain two support members to the support leg.

30. Adjustable furniture support apparatus according to claim 29 in which the retaining means is arranged to retain two support members wherein the angle between the two support members is adjustable to define any angle therebetween.

31. Adjustable furniture support apparatus according to claim 1 in which the support member comprises an annular member.

32. Adjustable furniture support apparatus according to claim 31 in which the annular member is arranged to locate around the retaining member.

33. Adjustable furniture support apparatus according to claim 31 in which the retaining member comprises a boss.

34. Adjustable furniture support apparatus according to claim 33 in which the boss is arranged to retain a first support member and a second support member wherein the first support member comprises a lower annular member whilst the second support member comprises an upper annular member.

35. Adjustable furniture support apparatus according to claim 34 in which a cover is arranged to urge the upper annular member, the lower annular member, or both downwardly to urge the tapered retaining surface of an or each annular member against a tapered retaining surface of the boss.

36. An item of furniture comprising the adjustable furniture support apparatus according to claim 1, comprising at least one support leg, the support leg comprising retaining means to retain a support member thereto such that the support member extends radially away from the a longitudinal axis of the support leg, the retaining means being arranged to retain the support member at an adjustable angle about the longitudinal axis of the support leg.

37. A method of adjusting furniture support apparatus, the method comprising retaining a support member to a support leg by retaining means such that the support member extends radially away from a longitudinal axis of the support leg, the method further comprising retaining the support member at a selected angle about the longitudinal axis of the support leg.

38. A method of reconfiguring an item of furniture the item of furniture comprising the adjustable furniture support apparatus according to claim 1, comprising at least one support leg, a support surface and a support member, the support leg comprising retaining means in order to retain the support member such that the support member extends radially outwards from a longitudinal axis of the support leg, the method comprising supporting the support member at a different angle about the longitudinal axis of the support leg.

39. A method according to claim 38 in which the method comprises providing a first item of furniture having a first support surface of a first shape and reconfiguring the item of furniture to provide a second item of furniture having a second support surface of a second shape.

40. Securement apparatus for securing a support surface to furniture apparatus, the securement apparatus comprising support means which is arranged, in use, to support the support surface, the support apparatus comprising an engagement portion which is arranged, in use, to locate within an opening provided by the furniture apparatus, the engagement portion being arrangeable to move from a first position to a second position whilst the engagement portion is located within the opening, the securement apparatus further comprising a securement potion which is arranged to couple the support surface to the engagement portion, wherein the support surface is secured to the furniture apparatus when the engagement portion is in the second position.

41. An item of furniture comprising securement apparatus for securing a support surface to furniture apparatus in accordance with claim 40 to the item of furniture further comprising a support surface.

42. A method of securing a securement apparatus to furniture apparatus according to claim 40, the method comprising locating an engagement portion of the securement apparatus in an opening provided by the furniture apparatus, the method further comprising moving the engagement portion from a first position to a second position whilst the engagement portion is located in the opening wherein the securement apparatus is secured to the furniture apparatus when the engagement portion is in the second position and the engagement portion is insertable into the opening when the engagement portion is in the first position.

43. (canceled)

44. (canceled)

45. (canceled)

46. (canceled)
